(19) United States
(12) Patent Application Publication
(10) Pub. No.: US 2010/0318286 A1
(43) Pub. Date: Dec. 16, 2010

(54) METHOD OF CREATING A SPEED ESTIMATION

(76) Inventors: Stefan Lorkowski, Berlin (DE); Peter Mieth, Berlin (DE); Ralf-Peter Schafer, Berlin (DE); Rob Schuurbiers, Amersfoort (NL); Lucien Groenhuijzen, Almere (NL)

Correspondence Address: Harness, Dickey & Pierce P.L.C., P.O. Box 8910, Reston, VA, 20195, US

(21) Appl. No.: 12/735,635

(22) PCT Filed: Apr. 22, 2009
(86) PCT No.: PCT/EP2009/054849

§ 371 Date: Aug. 4, 2010

Related U.S. Application Data
(60) Provisional application No. 61/071,338, filed on Apr. 23, 2008.

(51) Int. Cl. G08G 1/00

(52) U.S. Cl. 701/119

(57) ABSTRACT

A method of creating a speed estimation representative of vehicle speed along one or more road segments. In at least one embodiment, the method includes obtaining at least reference speed data from a reference source of data and second speed data from a second source of data, wherein the second source is different from the reference and the speed data is indicative of vehicle speed along the or each road segment; using the reference speed data to verify the second speed data and modifying the second speed data according to the verification; and generating an estimation of vehicle speed for the or each road segment based upon the verified second speed data.

This is application is National Phase entry of PCT Application number PCT/EP2009/054849 filed on Apr. 22, 2009, and claims priority under 35 U.S.C. §119 and/or 120 to U.S. Provisional Application No. 61/071,338, filed on Apr. 23, 2008, the contents of each of which are herein incorporated herein by reference in their entirety.

### FIELD OF THE INVENTION

This invention relates to a method of creating a speed estimation of vehicle speed on a road segment generally by combining data from a plurality of sources. In particular, but not exclusively, the data sources include speed data derived from GPS (Global Positioning System) probes and GSM (Global System for Mobile communications) data but may include data from a variety of other sources.

### BACKGROUND OF THE INVENTION

With ever increasing road traffic levels there is a desire for the rapid generation of traffic congestion reports in order to enable a rapid response thereto such as action to remove the cause of traffic congestion, and alerting road users approaching areas of congestion to allow them to take appropriate action, such as choosing an alternative route.

Existing methods generally depend on physical detection of the vehicles by direct visual observation or by using various kinds of sensors such as cameras or proximity sensors embedded in the roadway, etc. The former approach can provide only limited coverage due to the large number of personnel required, while the latter requires the installation in the road network of an extensive and expensive infrastructure.

It is also known to use data from mobile telephone networks such as GSM networks, in order to obtain further sources of traffic information and an example of such a system is shown in WO0245046. Such data from mobile telephone networks may be thought of as beneficial since it provides a further source of data on which traffic flow (ie vehicle speed) can be assessed.

### SUMMARY OF THE INVENTION

According to a first aspect of the invention there is provided a method of creating a speed estimation representative of vehicle speed along a road segment, the method comprising the following steps:
obtaining at least reference speed data from a reference source of data and second speed data from a second source of data, wherein the second source is different from the reference source;
using the reference speed data to verify the second speed data and modifying the second speed data according to the verification; and
generating an estimation of vehicle speed for that road segment based upon the verified second speed data.

An advantage of such a method is that the overall accuracy and associated confidence in the estimation of vehicle speed, is increased since the second speed data has been verified.

The method may include fusing the reference and second speed data to generate fused speed data which provides an estimation of vehicle speed along that road segment. The method may include fusing additional sources of data.

Thus, in some instances if the second speed data passes the verification with the reference speed data then there may be no modification thereof.

Possible data sources from which speed data may obtained include any of the following: data from road loops; data from cameras; toll booths; number plate recognition systems; Traffic Message Channel (TMC) messages (such as Alert C messages); Journalistic data (such as traffic announcements, etc.), LOng Range Aid to Navigation (LORAN-C) signals, GPS (Global Positioning Systems) enabled devices; GSM (Global System for Mobile Communications), UMTS (Universal Mobile Communications System) or other mobile telecommunications standard; any other position data source. Thus, the reference source of data and the second source of data may be any of these source although it will be appreciate that the reference source of data is likely to be chosen to be a source of speed data that is more accurate than the second source of speed data in order that the confidence in the speed data can be increased.

In some embodiments, the reference data may comprise speed profile data for the road segment for which the estimation of vehicle speed is being made. Such speed profile data may for example be a speed profile such as used in TomTom IQ routes. Such a speed profile may provide an estimation of the speed of a vehicle at a particular time of day in situations in which there is no or at least substantially no congestion. The reference data may be associated with mapping data including data on the road segment for which the speed estimation is being generated.

Data derived from mobile telecommunication devices includes deriving a probability of each handset being at a position according to measured changes of the signaling data such as through any of the following: Cell Handover, Timing Advance, signal strength or the like.

In one particular embodiment, the reference data source is data obtained from GPS devices and the second data source is data obtained from mobile telecommunications devices. At the present time, GSM derived data is more widely available than GPS derived data but is less accurate. As such, it may be possible to derive a correction factor, or the like, from the reference speed data that can be used to correct the second speed data.

The method may be applied to more than two sources of data; ie additional sources of data beyond the reference source and second source. That is the method may also verify further sources of data. Each further source of data may be verified with data from the reference source or may alternatively, or additionally, be verified by a further reference source.

The method may include generating the reference and/or second speed data from position data obtained, respectively, from the reference, second and/or any other data sources. The data sources for the position data may be the same as those for the speed data.

In some embodiments, the position data may comprise a location, such as provided by a grid-reference, or the like, which generally has a degree of uncertainty associated with the position that it provides. For example, position data generated by GPS tends to be accurate to around 10 m. Position data derived from GSM tend to be accurate to around 200 m.

Thus, the method may include any of the following steps a to j:
a: capturing reference position data from a reference and/or second source of data at a first time (t1). The second source of data may conveniently be a mobile telecommunications device, such as a mobile telephone, which may utilize GSM, UMTS or other such protocol. Thereby, the capturing the reference position data from the second data source may include capturing data from an active mobile telecommunications device, possibly in use, on a vehicle at a given time t1.
b: intersecting the position data with road network mapping data defining the road network in terms of road segments each representing a discrete part of the road network, so as to identify original possible road segments corresponding to the first geographical positional data. That is, the method may use the mapping data to constrain possible positions from the position data. Thus, road segments may be generated from each of the reference, second and/or additional sources of position data.
c: generating an initial probability vector representing the likelihood of the vehicle having arrived at a position on a given one of the original possible road for the original possible road segments. Again this may be performed for any of the sources of data.
d: capturing second position from the sources of data at a later time t2=t1+[Delta]t where [Delta]t is the actual transit time of the device between the first and second geographical positions. Again, this may be performed for any of the sources of data.
e: intersecting the second position data with the road network mapping data, so as to identify new possible road segments corresponding to the second geographical positional data. Again, this may be performed for any of the sources of data.
f: identifying available routes in the road network linking the possible road segments corresponding to the reference and second position data which routes are constituted by a series of road segments.
g: generating an updated probability vector representing the likelihood of the vehicle having arrived at a position on a given one of the new possible road segments in the road network corresponding to the second geographical positional data at the later time t2 via one of the available routes, for the new possible road segments. Again, this may be performed for any of the sources of data.
h: intersecting the available routes with expected average vehicle speed data for the road segments of each of the series of road segments constituting the available routes so as to determine expected transit times for the available routes. Again, this may be performed for any of the sources of data.
i: comparing the actual transit time with the expected transit times for the available routes so as to produce delay factors for the routes indicative of the degree of vehicular traffic congestion on the individual road segments thereof at the time. Again, this may be performed for any of the sources of data.
j: determining an average delay factor for a plurality of vehicles using a given road segment, which average is weighted on the basis of at least the likelihood of any of the available routes having been followed.

Some or all of the steps a to j may be utilized in generating speed data for any of the sources of data from the position data obtained from any of the sources of such data. Whilst, the steps a to j may be applied to any source of data they may be more applicable to sources of data that have a lower degree of accuracy; such as for example, mobile telecommunications devices. Devices that generate position data having a higher degree of certainty in a position may be able to simply rely on the position data rather than having to use the mapping data to constrain the position estimate obtained from the data source.

The method may comprise generating the estimation of vehicle speed on what may be termed a real-time, or at least a pseudo real-time, basis. That is, the estimation of speed data may be generated from time-to-time such that there is a short delay between obtaining position data and deriving speed data therefrom, or obtaining speed data, and verifying that speed data. A short period may be measured in terms of minutes and may be less than roughly any of the following times: 20 minutes; 15 minutes; 10 minutes; 5 minutes; 3 minutes; 2 minutes; 1 minute or the like.

The verification process may include weighting speed data with a weighting factor. In some embodiments, the weighting factor may be determined for a given source of the data.

In alternative, or additional embodiments, the weighting factor may be specific for a given road segment. The method may be arranged to generate this road segment weighting factor, perhaps by the outcome of previous verifications such that it is generated by historical data. Such a method can help to reduce processing burden as it can help to make the initial data for the verification process more accurate.

As such, the method may, over a period of time, learn the weighting factor to be applied to the second speed data. Further, the method may also learn weighting factors for further sources of speed data which will generally be different when compared to the weighting factor applied to speed data generated from the second source.

The weighting factor applied to given speed data may be decayed with time. This decay may be on an exponential, or may be linear or may be any other suitable mathematical function as a basis. The skilled person will appreciate that as data ages it will become less representative of the actual conditions on a road segment and as such, it is desirable for that data to have less effect in generating the estimation of vehicle speed for that road segment.

The method may calculate distributions between speed data from the reference and second, or further, data sources. The distribution may be analyzed and the output of this analysis used to determine how the second speed data should be modified. The skilled person will appreciate that one possible outcome is that no modification is required.

The method may calculate a normal distribution for the speed data. This is generally performed for a given road segment. The method may subsequently calculate the mean and/or the variance of the normal distribution.

The mean may be utilized to determine a bias within the speed data generated from the second, and/or further, data sources; the skilled person will appreciate that if the data sources are providing substantially the same speed data then the mean should tend toward zero. The method may subsequently modify the second, and/or subsequent, speed data to take account of the bias, generally by removing the bias from the second, and/or subsequent, speed data.

The variance may be utilized to determine the level of noise within the speed data generated from the second and/or subsequent data sources. A similar method may be applied to speed data generated from the reference data source. The variance may be used in generating the road segment weighting factor. The skilled person will appreciate that such embodiments may be arranged so as to have the effect of giving a higher weighting to speed data that is consistent; ie there is more confidence in any one reading.

The method may also assign a probability to the speed data from each of the data sources having been generated from a vehicle upon the same road segment. For example, in areas in which there is a high density of road segments, or other forms of transport, it may be that data generated from the different data sources may not necessarily all relate to the same road segment. It will be appreciated that such a tendency may increase as the accuracy of a data source decreases and may also increase in urban environments wherein there may be a number of roads in proximity.

In some embodiments, the probability may be used in the generation of the road segment weighing factor. As such, road segments in which there is little confidence that the reference speed data and second speed data are generated by vehicles travelling on the same road segment will apply less weight to the speed data generated by the second, and/or subsequent, sources of data.

The method may, and generally will be, repeated for a plurality of road segments covered by the road network mapping data. Indeed, the method may be repeated for each segment covered by the road network mapping data. However, in some embodiments, the method may be limited to being performed for road segments for which there is sufficient data from both the reference and second (and any other) sources of data.

The method may comprise using a training mode in which the road segment weighing factor is learnt with the method offline. Offline may be thought of as either not generating an estimation of vehicle speed or not utilizing the estimation of vehicle speed in a determination as to whether or not there is congestion.

In other embodiments, the road segment weighting factor may be learned with the method online and generating the estimation of vehicle speed.

The method may determine whether or not there is congestion on a road segment the estimation of vehicle speed so generated. The estimation of vehicle speed may be compared with a free-flow speed for that road segment; ie the speed at which traffic would flow when there was no congestion present. The free flow speed may be provided by a speed profile for that road segment giving the free flow speed over predetermined time periods. A speed profile may be as given the TomTom IQ routes.

Should the estimation of vehicle speed fall below a predetermined percentage, or other measure, of the free flow speed, then the method may determine that there is congestion on that road segment and that an alert should be raised.

According to a second aspect of the invention there is provided a road traffic network reporting system arranged to monitor vehicle speed along one or more given road segments, the system comprising:
a storage device; and
processing circuitry connected to the storage device;
the storage device being arranged to store:
   reference speed data generated from position data received from a reference source of position data; and
   second speed data generated from position data received from a second source of position data;
the processing circuitry being arranged to
a: process the reference and second speed data to verify the second speed data;
b: modify the second speed data according to the verification
c: generate an estimation of vehicle speed for that road segment based upon the verified second speed data.

The processing circuitry may also be arranged to fuse data from the reference, second and any other data sources and to generate the speed estimation from the fused speed data.

According to a third aspect of the invention there is provided a machine readable medium containing instructions which when read by a machine cause that machine to perform the method, or at least a part of the method, of the first aspect of the invention.

According to a fourth aspect of the invention there is provided a machine readable medium containing instructions which when read by a machine cause that machine to function as the, or at least a part of, the system of the second aspect of the invention.

In any of the above aspects of the invention the machine readable medium may comprise any of the following: a floppy disk, a CD ROM, a DVD ROM/RAM (including a −R/−RW and +R/+RW), a hard drive, a memory (including a USB memory key, an SD card, a Memorystick™, a compact flash card, or the like), a tape, any other form of magneto optical storage, a transmitted signal (including an Internet download, an FTP transfer, etc), a wire, or any other suitable medium.

Further, the skilled person will appreciate that features discussed in relation to any one aspects of the invention are suitable, mutatis mutandis, for other aspects of the invention.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 (Prior Art) schematically shows an example of a Global Positioning System (GPS);

FIGS. 2 and 3 (Prior Art) each show part of a road network and its relationship to a part of a mobile telecommunications device network;

FIGS. 4 and b shows a further exemplification of the process shown in FIG. 3;

FIG. 5 shows a graph highlighting considerations when sources of data are combined; and

FIG. 6 shows a flow chart outlining an embodiment of the described invention.

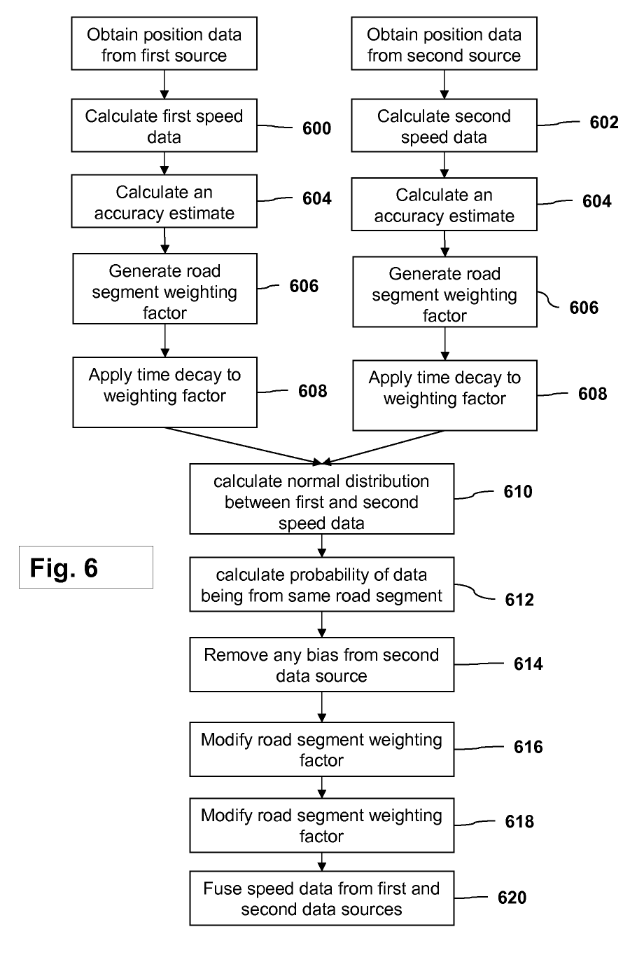

### DETAILED DESCRIPTION OF THE DRAWINGS

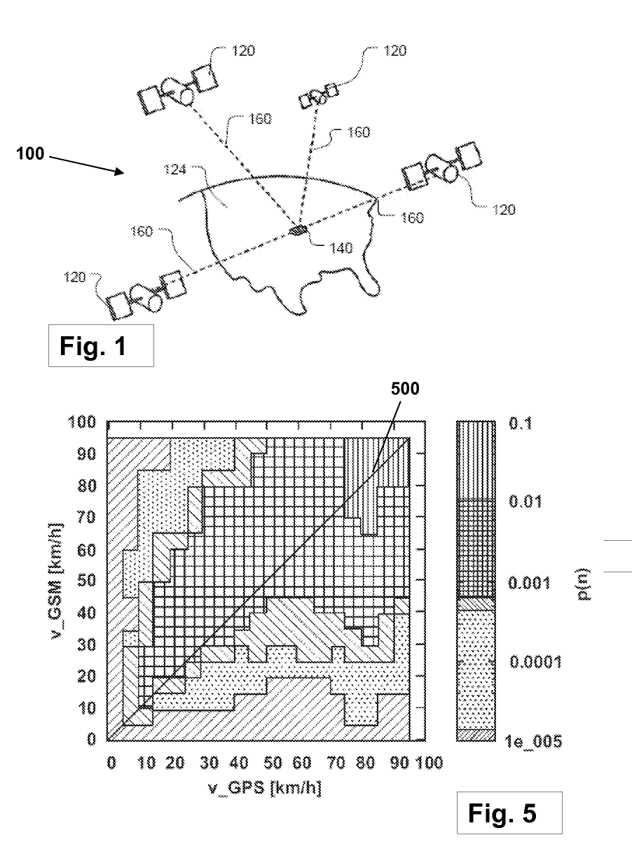

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in precise orbits. Based on these precise orbits, GPS satellites can relay their location to any number of receiving units. However, it will be understood that Global Positioning systems could be used, such as GLOSNASS, the European Galileo positioning system, COMPASS positioning system or IRNSS (Indian Regional Navigational Satellite System).

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize an accurate frequency standard accomplished with an accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

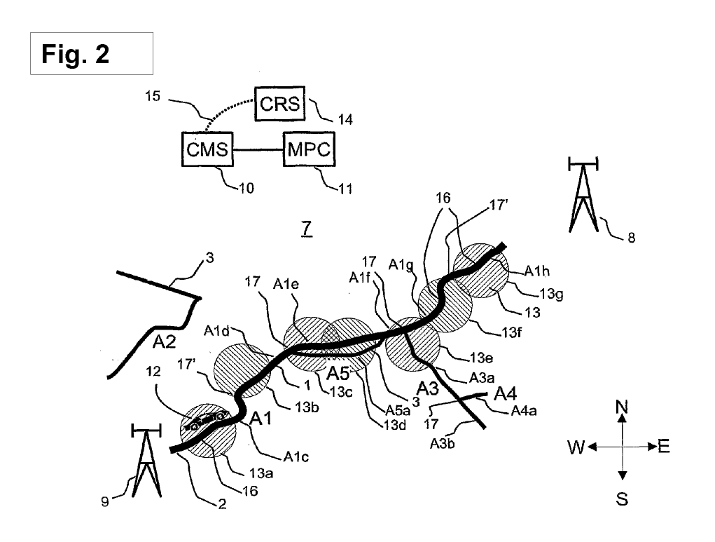

FIG. 2 shows part of a road network 1 (not to scale) comprising a major highway 2 which has the name A1, and various other minor country roads 3, with the names A2, A3, A4, A5 in an area served by a mobile telecommunications device network 7, including a plurality of transmitter/receiver stations 8,9 and a call management system 10 provided with a mobile telecommunications device geographical positioning system or centre (MPC) 11, for example, one based on GPS technology as described briefly with reference to FIG. 1.

When a motor vehicle 12 is driven along highway A1 with a cell phone or other mobile telecommunications device (MS device) aboard in use, the positioning system 11 will periodically generate geographical position data for the device. This data is in the form of a more or less extended geographical area, depending on the precision of the particular positioning system used, which areas are represented in FIG. 2 by shaded cells 13 (13a, 13b, to 13g) with typically a diameter of around 20 meters. This geographical position data is intersected with road traffic network data representing the geographical position of individual road segments 16 (AIc AIh, A3a, A3b etc) of each of the roads A1, A2, A3, etc. by a congestion reporting system (CRS) 14 in order to determine speed data for that road segment at an instant in time. Thus, this speed data for the road segment on which it was generated provides what may be thought of as reference speed data generated from a reference source (in this instance the GPS system 100).

The individual road segments 16 (AIc, A3a, etc.) generally consist of lengths of a road 2,3 extending between successive junctions 17 with other roads 3,2 which constitute nodes in the database comprising the road network mapping data representing the geographical position of the individual road segments 16.

Where the length of road 2,3 between successive junctions 17 is too long, then this may be broken up by inserting additional nodes 17′ to divide the road into road segments each of which has a length not greater than say roughly 500 meters. Thus at the SW end of road A1 an additional node 17′ is used to break the road 2 up into two road segments A1e and Aid.

It should incidentally be noted that although for ease of illustration and clarity, the Figures show each road as just one road segment eg AIc, in practice such roads would normally each correspond to two road segments eg A1e′ and A1e″, with one for each direction of travel along the road. Naturally this affects the amount of processing involved insofar as, at least for an initial geographical position, twice as many road positions have to be taken into account since it will not be known in which direction the vehicle is traveling. Once a second geographical position has been captured, though, it will become evident that the second road position(s) can only be linked to the first road position(s) by a route(s) using those road segments heading in one direction and not in the other direction, whereby the latter can be discarded from the road segments under consideration.

The congestion reporting system 14 is coupled 15 to the call management system 10 (as further described hereinbelow). The system 14 recognizes which road segments 16 of the road network 1 correspond to (are consistent or compatible with) the GPS (Geographical Position System) data received for the vehicle 12.

In some cases the GPS data 13a, 13g will be compatible with only one possible road position ie a particular road segment 16-A1c, AIh, respectively of the A1 highway. In other cases the geographical position data 13c, 13e would be compatible with the vehicle being on any one of two or more different road segments 16. In one case parts of highway A1 (road segment A1e) and minor country road A5 (road segment A5a) are present within the geographical area defined by geographical position data 13c, and in the other case different parts of highway A1 (road segments AIf, AIg) and minor country road A3 (road segment A3a) are all compatible with geographical position data 13e.

The congestion reporting system 14 presents the road position data for such cases as a probability vector which comprises the relative probabilities of the vehicle 12 being on one or other road segment (see further description hereinbelow).

The probabilities may be based on one or more suitable factors such as, for example, the length of the road within the geographical area under consideration and the classification of the road. In the case of geographical area 13e highway A1 has a higher classification than minor country road A3 and thus A1 road segments have a higher probability rating than road segment A3a. On the other hand the length of road segment A3a within geographical area 13e is greater than that of each of road segments AIf, AIg which would tend to weight the probability of the vehicle being on one or other road segment in the other direction, albeit that in this particular case the difference in classification might still be expected to outweigh the difference in road length. Where only a single road segment (e. g. AIh) intersects with the geographical position data (13g) it will be appreciated that the relevant part of this road has a probability of 100% or 1.

Once a moving MS device which is “active” (ie in use for sending and/or receiving some kind of MS telecommunication or simply exchanging data with the call management system 10 for network management purposes) has been detected, that is to say one in a moving vehicle 12, then this can be tracked for the duration of the period in which it remains active. The second (and subsequent) road position data (13b-13g) can be generated for it by intersecting the geographical position data with the road network mapping data as hereinbefore described in relation to the GPS speed data and then carrying out additional processing as described hereinbelow.

The skilled person will appreciate that in some embodiments, if a data source is of sufficient accuracy then it may be determined that matching position data to road and assigning probabilities may not be necessary. For example, if the accuracy of the position data is better than the feature size of a road segment then it may simply be sufficient to match position data to a road segment since there will be a sufficiently high confidence that the position will be on the road segment indicated by the position data.

In other embodiments, it may not be necessary for the MS device to be active (ie in use for sending and/or receiving some kind of MS telecommunication or simply exchanging data with the call management system 10 for network management purposes) for the device to be tracked using GPS position data generated by the MS device. The MS device may for example may be arranged to upload GPS position data via other means. Indeed, the MS device may be arranged to store GPS position data and upload that GPS position data from time to time (which may be periodically or at no fixed period such as when a communication channel becomes available).

A probability vector representing the second road position 16 (Aid) is generated by means of constructing a transition matrix representing each of the available routes between the first and second road positions 16. In some cases such as the road segments AIc→Aid corresponding to geographical positions 13a, 13b, respectively, there will only be a single route AIc→Aid available. In other cases such as road segments Aid, A1e, A5a corresponding to geographical positions 13b, 13c, there will be more than one route available (Aid→A1e or Aid→A5a). Thus with a vehicle traveling from geographical position 13b to geographical position 13c it starts off on the highway A1 but ends up either remaining on highway A1 or driving onto minor country road A5. Thus there are two possible routes available compatible with the first and second geographical positions detected.

Once there has been produced the transition matrix representing the likelihood of either of these available routes having been followed simply on the basis of the road position data (the likelihood of any vehicle being on any particular road at the time or the relative likelihoods of available routes) ie a “static” transition matrix independent of specific vehicle transit data, this transition matrix is then further refined by taking into account the actual transit time [Delta]t of the vehicle between the first and second road positions.

The congestion reporting system 14 also holds data relating to the expected speed of travel along a particular road segment. This may be based simply on the classification of the road, for example, 60 mph for a highway and 35 mph for a minor country road, or may be a speed profile generated for that individual road segment, or may take into account predetermined additional factors such as time of day, day of week, or may even involve live updating where, for example, the average road traffic speed has been reduced somewhat during a given period due to volume of traffic but the road has not been subjected to any particular incident or circumstance which would actually disrupt the flow and prevent the traffic from flowing at a reasonably steady rate.

By comparing the actual and expected vehicle transit times [Delta]tx between the first and second road positions there may then be generated a time dependent transition matrix representing the likelihood of this vehicle having traveled along a particular route. Thus, for example, if the expected transit time for the vehicle between a first road segment Aid and a second road segment A1e (following highway A1) was 22 seconds and for a second road segment A5a (going from highway A1 onto minor country road A5) was 58 seconds and the actual time was 30 seconds then it may be seen that the actual time was slower than that expected for the first route but significantly faster than that expected for the second route. Given that it is generally significantly less likely that a vehicle would go much faster than the expected speed, than that it would go slower than the expected speed, the congestion reporting system 14 would adjust the initial transition matrix to increase the probability of the route Aid→A1e remaining on main highway A1 relative to that of route Aid→A5a turning off onto minor country road A5.

For the purposes of determining expected transit times, it is of course necessary to know what distance has been traveled. This information is generally available for each road segment within road network mapping data that is being processed.

In the case of geographical position 13c it may be seen that, at the time this position 13c was captured, the vehicle could have been positioned anywhere in the first half of road segment A1e (or A5a). In the case of geographical position 13b the vehicle could have been at the (NE) end of road segment A1e or anywhere in the first half of road segment Aid. In order to facilitate the calculation of the expected transit time [Delta]tx the system makes a standard assumption each time such as that the vehicle is at the earliest part of the (or each) road segment 16 with which the geographical position 13 is compatible.

It will be appreciated that as the probability of the vehicle following one route rather than another is increased, then this can be used in order further to refine the vectors representing current road position and transition matrices representing routes leading thereto, iteratively. Thus, for example, if the time dependant matrix were to indicate that there was a high probability that a particular vehicle was following a route Aid→A1e staying on highway A1 rather than a route Aid→A5a turning off onto minor country road A5, then this could be used to refine not only the updated second probability vector derived from geographical position 13c, but also the earlier generated first probability vector derived from preceding geographical position 13b.

For example, geographical position 13b is consistent with the vehicle 12 being on either of road segments A1e or Ai d. The former possibility would imply a greater travel distance and hence higher speed for a given transit time. If this higher speed were significantly greater than the expected speed then this would substantially reduce the probability of the vehicle being on road segment A1e and increase that of the vehicle being on road segment Aid, thereby increasing the probability of route Aid→A1e having been followed and decrease that of route AIc→A1e.

When a probability vector representing the relative likelihood of the possible road segment positions 16 at a given time and the relative likelihood of any of the available routes to the respective road segment positions having been followed (after filtering out low probability routes), has been generated, then the routes may be split up into their road segment segments, each representing a given length of a particular road, and the actual transit time for the route distributed across the segment road segments (in proportion to their lengths and expected road speeds), and the congestion reporting system 14 generates expected transit time reports for the particular vehicle under consideration for each segment road segment.

In some embodiments, though, the congestion reporting system 14 generates an expected transit time [Delta]tx for the whole route by summing expected transit times for each of the individual road segments thereof, and then divides this into the actual transit time [Delta]t detected to produce a delay factor for the whole route. Whilst the delay factor could in principle vary between the different road segments included in the route—for example, when turning off a congested highway onto a minor road, for most practical purposes it may conveniently be assumed that the (same) delay factor applied equally for each of the road segments included in the route.

The congestion reporting system 14 then averages the delay factor reports generated for all available vehicles for a given road segment to obtain an average delay factor for the particular road segment. The delay factor reports used for this could simply be those generated at the time, but more commonly would include at least some earlier reports, which have been suitably aged or decayed to reduce their weighting in the averaging process. The average delay factor thus obtained gives an indication of the delay (if any) to which vehicle traffic on that road segment is being subjected to at the time and hence the status or degree of congestion of the road network thereat.

FIG. 3 illustrates the use of another kind of system for generating geographical position data in the same road network 1. In this case the call management system 10 does not have a dedicated geographical positioning system but instead the congestion reporting system 14 makes use of an integral segment of the call management system 10. Such a source of data may be thought of as a second source of speed data which generates second speed data.

In more detail, the call management system 10 in FIG. 3 depends on the use of timing advance zones for managing the receipt and transmission of calls between the MS devices and the transmitter/receiver stations 8,9. Thus when the call management system 10 detects an active MS device (ie one which is in use) it continually monitors which timing advance zone the device is in. These timing advance zones are in the form of part annular zones 21 which have a limited overlap with neighboring zones at which a timing advance, to which the MS device is subject to, is incremented or decremented.

When an active MS device (on board the vehicle 12) enters the overlap area the device may operate with a timing advance under either the first or second timing advance zone. Thus the device may switch from the first timing advance to the second timing advance at any point within the overlap area (conveniently called the timing advance boundary zone) between the first and second timing advance zones—and indeed could flip back and forth until it leaves the overlap area and clears the first timing advance zone entirely. In principle, when the MS device switches from the first timing advance to the second one, all that the call management system knows is that it is at a position somewhere within the second timing advance zone, which position may be within or outside the overlap area. In practice given the short time intervals (typically 0.5 seconds) between successive captures of geographical positioning data, we will know that when a timing advance switch has been detected, the device would definitely have been within the overlap zone some time during this short time interval, and by substituting a limited degree of timing uncertainty for a greater degree of positional uncertainty, can assume that in the case of geographical position captures occurring when a liming advance switch is detected, the MS device is within the limited overlap area (timing advance boundary zone) rather than the whole of the new timing advance zone. As may be seen from FIG. 3, the geographical area of even the more limited timing advance boundary zone 22 may still be considerably larger than the geographical area 13 defined by the GPS system used in FIG. 2 and thus will often contain a larger number of road segments so that the geographical positioning data obtained will be compatible with a greater number of road segment positions.

It can also be seen that the geographical areas are usually larger, so the transit limes determined (between different road segment positions), are rather longer. This will have a negative effect on the probabilities attributable to the various possible road positions and available routes therebetween, so that there will generally be less confidence in individual identifications of likely road positions and routes. Nevertheless, in principle, the congestion reporting system 14 operates in a substantially similar manner to that described hereinabove, comparing expected transit times with actual transit limes, and determining average delay factors for individual road segments.

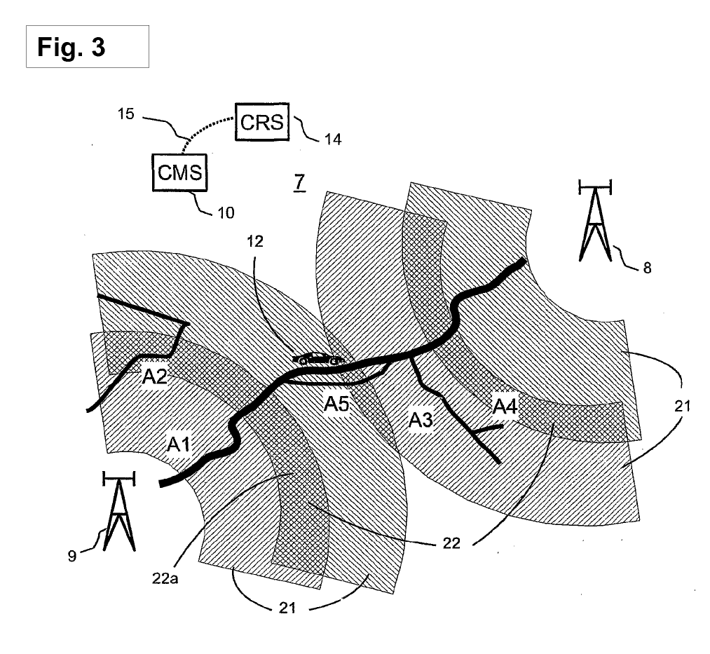

This is further illustrated with reference to FIGS. 4a and 4b in which a base station 400, which is perhaps a GSM base station, is provided in the vicinity of a road network 402 comprising three roads 1, 2 and 3 (which are each divided into road segments as discussed above). The zone 404 illustrates the most certain location area of an MS device. Thus, it will be seen in FIG. 4a the position of a vehicle may correspond to several road segments including those that are part of roads 1 and 2.

FIG. 4b shows a further view in which the TA zone that is detected is expanded to the area shown as 406. The vehicle position may correspond to positions on roads 1 and 2. Using the techniques described above by tracking successive positions it may be possible to eventually determine the route being taken by the vehicle.

It will be seen, from FIG. 4a that as the MS device moves further away from the base station 400 then the area in which it may be located expands. As such, the further the MS device is away from the base station 400 then the greater the uncertainty in its position and the greater the desire to use other sources to clarify the position.

Although, as described above, they are less accurate, GSM probe data technologies (ie using MS device) have an advantage in that they provide a high penetration of data coverage in view of the number of devices that are in use when compared to device that are able to return position using GPS in anything close to being thought of as real time. It will be appreciated that in order to be effective for helping avoid traffic congestion then the estimation of speed on a road segment is advantageously performed on-line with a delay of on the order of minutes between position data being obtained and the speed estimation for the road segment being generated.

Although the use of the Timing Advance (TA) measurement is described herein, other embodiments, may use other control signals of the telecommunication system such as service Cell-ID, handover of a handset from one cell to the next service cell, signal strength or the like each of which may also be used to determine the position of a handset.

Thus, from the above discussions it will be seen that use of GSM position data can lead to uncertainty in vehicle position, particularly in dense road networks. As such the accuracy of any speed data that is generated therefrom may also be of limited accuracy. Additionally, it may also be difficult to determine differences between different types of transport; for example if a railway track passes in proximity to a road, it may be difficult to determine whether the GSM data is generated from the road or railway.

Thus, from the above, it will be seen that it is possible to determine the position of a vehicle using position data derived from different sources; GPS and GSM data in the above examples. The skilled person will appreciate that other data sources are also possible and include: data from road loops; data from cameras; Traffic Message Channel (TMC) messages (such as Alert C messages); Journalistic data (such as traffic announcements, etc.), LOng Range Aid to Navigation (LORAN-C) signals, data from toll booths, number plate recognition systems or any other position data source. Data from each of these sources will have advantages and also weaknesses some of which are discussed above.

Thereby, by verifying data generated from various sources, it becomes possible to increase the quality and/or quantity of the speed data that can be generated. Generally, a speed data from a more accurate source is used as reference data to verify speed data from a less accurate source.

Such combination of data from different sources may be thought of as a data fusion process which is now described in relation to an embodiment of the invention. However, in the embodiment being described and before the fusion is performed cross validation (ie verification) between the GPS position data (reference data source) and GSM position data (second data source) in order to analyze the reliability of the speed data generated from the GSM position data.

For clarity, the below description is made with reference to specific data sources; GSM and GPS. However, the skilled person will appreciate that the method being described could be applied mutatis mutandis to speed data generated from other data sources.

An average speed is calculated from the position data (both GPS and GSM) for each road segment for which there is sufficient data (steps 600, 602). This is done by calculating a weighted average of the speed observations which are calculated from the position data as described above. Each of these observations is supplemented by an estimation of the probability that the real speed is within a given range around an observation (this estimation may be called ‘accuracy’)—step 604. This accuracy is used as weight for the observation to generate a road segment weighting factor—step 606.

The accuracy estimations of the observations are calibrated by a-priori weights for GPS probes; ie the weighting factor is generated according to the source of the data. It will be appreciated from the above that position data generated from GPS position data is inherently more accurate than position data generated from GSM position data. For GSM derived observations the weighting factor is learnt per road segment based on the comparison with GPS derived data as described further below.

The skilled person will appreciate that the relevance of an aging speed observation decreases over time; as time passes a speed observation is less likely to reflect the situation of the traffic flow on the road segment. To take account of this loss of accuracy the weighting factor of an estimation of an observation is decreased over time using an exponential function; ie it is decayed—step 608. If the accuracy falls below a given value the observations is finally removed from the system. Thus, the speed observation is likely to be removed from the system once the position data from which it is derived is older than a predetermined time.

In the embodiment being described, the predetermined time is roughly 5 minutes in order that the speed data generated from the position data reflects what may be thought of as the “real-time” conditions on a road segment. However, in other embodiments, the predetermined time may be other periods, such as roughly any of the following: 3 minutes, 10 minutes, 15 minutes, 30 minutes or more.

As time passes a record of speed data for a given road segment is built up for each source of data that has generated a speed for that road segment. In the embodiment being described this includes both GSM and GPS data. In other embodiments, further sources of data may also generate speed data for a given road segment.

In order to increase the accuracy of any one source of data it is possible to use the characteristic of one source of data to improve the speed generated by another source of data. In the embodiment being described, GPS data is used to verify GSM data and to modify that GSM data in order to increase the accuracy of speed data generated for a given road segment.

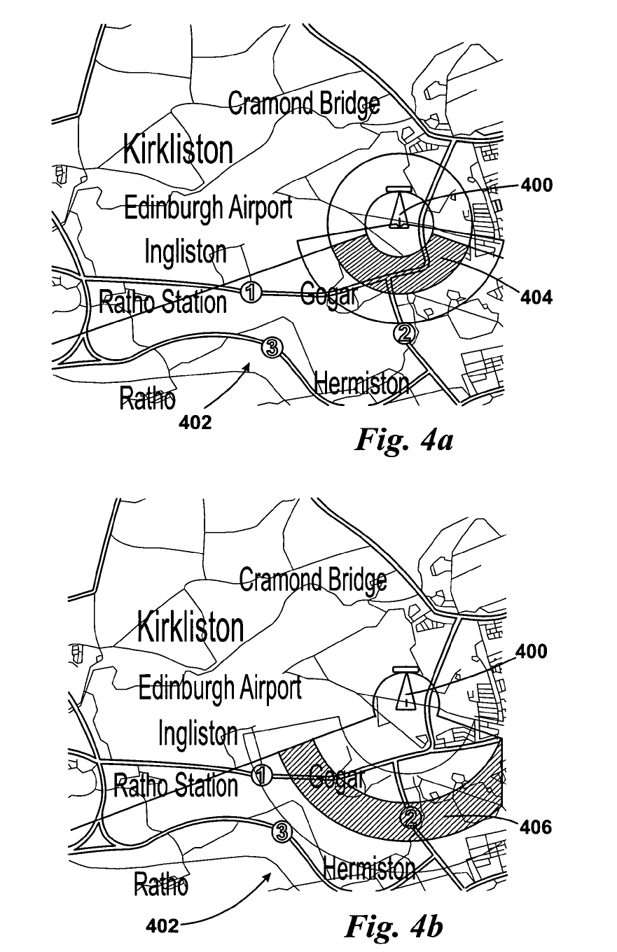

This will be described further in relation to FIG. 5 which highlights the bias between speed data generated from both GPS and GSM sources and will be used to explain a bias of speed data generated from GSM data on a road segment and how this is accounted for using GPS data.

The horizontal axis of the graph represents the speed data of vehicles along a road segment (ie the velocity) calculated from GPS data and the vertical axis of the graph represents the speed profile data of vehicles along a road segment (ie the velocity) calculated from the GSM data. An optimal speed match of both sources is represented by a 45 line 500 running left to right (ie with GPS velocity equal to GSM velocity). The shading of the graph indicated where the actual correlation lies with a higher correlation being indicated by the shading toward the top of the scale located at the right of the Figure (ie the vertical lines).

It will seen that the correlation between the two sources of data tend to be higher above the line 500 indicating that the GSM speed data tends to be higher for any given road segment than speed data calculated from the GPS data. As discussed above, data generated from GPS sources, is of higher accuracy but tends to have lower coverage when compared to data generated from GSM sources.

Thus, in the embodiment being described data received from a GPS source that is received within a predetermined time period of data received from a GSM source may used to verify the quality of the GSM data; ie to learn about the quality of the GSM data. In the present embodiment, this predetermined time is roughly 1 minute but this need not be the case in other embodiments and other time periods may be used: such as 15 seconds, 30 seconds, 45 seconds, 75 seconds, 90 seconds, 105 seconds, 2 minutes, 3 minutes, 5 minutes, or the like.

In order to perform this verification, two groups of statistics are calculated for each road segment:
(a) statistics of the distribution of the deviation in speed data generated from GPS and GSM data sources—step 610, and
(b) the probability (step 612) of GSM data describing the same traffic state as the GPS data. This tries to ensure that the road segment is being referred to by the data. For example, referring to FIG. 2 what is the probability that the data relates to road segment A1 and not road segment A5 when the two roads are adjacent one another?

Discussing the first step (a) of the verification further, it is assumed that a normal distribution will exist between speed data generated from the GPS and GSM data sources for a given road segment. In the embodiment being described, the first two moments (mean and variance) of this distribution are calculated. The mean should optimally tend to 0, if there is no systematic bias in the speed data generated from data from the GSM source. If the mean significantly differs from 0 it is used to correct the speed data generated from the GSM source. Thus, the mean may be thought of as a bias that can be removed from the GSM source—step 614.

The variance is a quantifier for the noise of GSM probe data on that road segment. The reciprocal of the variance is used as a weight to be applied to speed data generated from GSM data against other sources during the later fusion process. Thus, road segments having a high bias in the speed data generated from GSM measurement will have a lower weighting applied to them in the later fusion process. Thus, the variance can be used to modify the road segment weighting factor—step 616.

Discussing the second step (b) of the verification further, it is assumed that a normal distribution between speed data generated from the GPS and GSM data sources does not hold for all road segments. On some road segments multimodal distributions are observed which can be due to systematic mis-matched data from GSM data from other roads (eg road A1 and A5 in FIG. 3), other modes of transport (eg an MS device travelling in a train adjacent a road), or the like. To quantify this effect additional statistics are maintained for each road segment. These statistics describe the probabilities for having GSM sources reporting free-flow speed while GPS sources report congestion and vice versa. This is interpreted as the risk for seeing irregular GSM sources on a road segment. Again, this assessment may be utilised to modify the road segment weighting factor 618.

Based on this knowledge a number of GSM sources is determined that should report a congestion on a given road segment before a predetermined confidence level is exceeded; ie it is determined that there is congestion on that road segment. This estimation of the confidence is used to decide there really is congestion on a road segment that should be flagged.

Although the above discusses a comparison between speed data obtained from GPS and GSM sources, a similar analysis may also be performed between other data sources. This may be to take in order the advantages of any one data source to mitigate the disadvantages of another data source. For example, the learning of speed biases may be applied to traffic incident messages based on the ALERT-C protocol. The speed range of every LOS (Level Of Service) announcement of the ALERT-C protocol may be analyzed and tuned against data from GPS sources (or other data sources) as described in relation to FIG. 5 for the case of comparison between speed data generated from GPS and GSM sources. Due to the aggregated speed range of TMC Level-of-service events the a-priori weighting for the speed calculation tends to be low compared to continuous speed ranges from other data sources (such as GPS sources).

Once the above processing has been performed there is an increased level of confidence in the speed data generated from the different sources for any given road segment and the speed data from the various sources may be combined; ie fused. This fusion generates a single fused speed data for each road segment for which there is sufficient data—step 620.

The fused speed data is used to determine whether or not there is what may be termed a traffic incidents (ie congestion) on any one road segment. This is determined if the fused speed data that vehicle speed for that road segment drops under a predetermined threshold speed. This threshold is in this embodiment determined to be a fraction (ie a percentage) of the free flow speed of the road segment. The free flow speed is the speed at which a vehicle would generally pass along that road segment. The free flow speed in some embodiments is varied according to the time of day (for example the free flow speed may be given by a speed profile such as from TomTom IQ routes) whilst in other embodiments may be a set speed for that road segment. When a road segment or a number of neighboring road segments pass the incident threshold (ie in this embodiment, it is determined that the fused speed data indicates a vehicle speed lower than the predetermined percentage of the free flow speed) and therefore vehicles travelling along that segment will have a longer delay than would usually be the case a traffic alert can alert users as to the incident.

In some embodiments, it is possible to determine an overall length of a delay by looking at connected road segments and determining whether these show delays. If such connected segments do show delays then the total delay may be communicated as being the delay across the connected road segments. The skilled person that connected does not necessarily mean next to one another and that there may be road segments in between. This is because in a traffic queue so-called stop-start conditions can occur wherein traffic can suddenly start moving only to stop shortly thereafter. As such, some road segments may show a high free flow speed despite being within an area of congestion.

It will also be well understood by persons of ordinary skill in the art that whilst the embodiment described herein implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

Reference is made herein to GSM mobile telecommunications systems. The skilled person will appreciate that there are a variety of other transmission protocols that are possible and that GSM is used as an example only. For example, other protocols may include UMTS (Universal Mobile Telecommunication System); GPRS (General Packet Radio Service), CDMA2000, TD-SCDMA, or the like. Indeed, this may be extended to other technologies such as WiMax, WIFI, or the like.

1. A method of creating a speed estimation representative of vehicle speed along one or more road segments, the method comprising:
obtaining at least reference speed data from a reference source of data and second speed data from a second source of data, the second source of data being different from the reference source of data and the speed data being indicative of vehicle speed along the one or more road segments;
using the reference speed data to verify the second speed data and modifying the second speed data according to the verification; and
generating an estimation of vehicle speed for the one or more road segments based upon at least the verified second speed data.

2. A method according to claim 1, further comprising:
initially generating at least one of the reference speed data and the second speed data from position data obtained, respectively, from the reference source and second data sources.

3. A method according to claim 1, wherein the verification includes weighting speed data with one or more weighting factors, determinable for a given source of speed data, by learning from earlier data.

4. A method according to claim 1, arranged to generate a road segment weighting factor based upon the outcome of previous verifications.

5. A method according to claim 3, the one or more weighting factors applied to given speed data is decayed with time.

6. A method according to claim 4, further comprising:
assigning a probability to the speed data from each of the data sources having been generated from a vehicle upon the same road segment and using the assigned probability to generate, or at least modify, the road segment weighting factor.

7. A method according to claim 1, further comprising:
calculating a distribution between speed data from the reference data source and the second data source, which may be a normal distribution.

8. A method according to claim 7, wherein the calculating includes calculating at least one of a mean and a variance of the normal distribution.

9. A method according to claim 1, further comprising:
determining a speed bias within the speed data generated from second data source and subsequently modifying the second speed data to take account of the bias.

10. A method according to claim 8, further comprising utilizing the variance to determine a level of noise within the speed data generated from the second data source, the determination being utilizable in generating the road segment weighting factor.

11. A method according to claim 1, further comprising:
reporting a delay for the one or more road segments upon the generated speed estimation falling below a threshold.

12. A road traffic network reporting system arranged to monitor speed data for one or more road segments, the road traffic network reporting system comprising:
a storage device; and
processing circuitry connected to the storage device, the storage device being arranged to store reference speed data generated from position data received from a reference source of position data and to store second speed data generated from position data received from a second source of position data, the processing circuitry being arranged to
process the reference and second speed data to verify the second speed data,
modify the second speed data according to the verification, and
generate a fused speed data by fusing the reference and second speed data to generate an estimation of vehicle speed for the one or more road segments.

13. A system according to claim 12, wherein the processing circuitry is arranged to generate a delay warning upon the speed estimation falling below a threshold.

14. A machine readable medium containing instructions which, when loaded onto a machine,
cause the machine to perform the method of claim 1.

15. A method according to claim 2, wherein the verification includes weighting speed data with one or more weighting factors, determinable for a given source of speed data, by learning from earlier data.

16. A method according to claim 4, the one or more weighting factors applied to given speed data is decayed with time.

17. A method according to claim 5, further comprising:
assigning a probability to the speed data from each of the data sources having been generated from a vehicle upon the same road segment and using the assigned probability to generate, or at least modify, the road segment weighting factor.

18. A method according to claim 9, further comprising utilizing the variance to determine a level of noise within the speed data generated from the second data source, the determination being utilizable in generating the road segment weighting factor.

19. A machine readable medium containing instructions which, when loaded onto a machine, cause the machine to function as the, or at least part of, the system of claim 12.
